(19) United States
(12) Patent Application Publication
(10) Pub. No.: US 2007/0160034 A1
(43) Pub. Date: Jul. 12, 2007

(54) Dual-protocol dual port telephone and method to connect another dual-protocol dual port telephone via IP network directly and without installation

(75) Inventor: Victor Koretsky, Raanana (IL)

Correspondence Address: BROWDY AND NEIMARK, P.L.L.C.;624 NINTH STREET, NW, SUITE 300, WASHINGTON, DC, 20001-5303, US

(73) Assignee: D.S.P. Group Ltd, Herzliya Pituach (IL)

(21) Appl. No.: 11/326,463

(22) Filed: Jan. 6, 2006

(51) Int. Cl. H04L 12/66

(52) U.S. Cl. 370/352; 370/401

(57) ABSTRACT

A VoIP telephone call is seamlessly routed via an IP network between a dual mode, dual protocol source telephone and a dual mode, dual protocol target telephone both having two communication ports having respective first and second addresses for connecting to a non-IP network and an IP network, respectively. Upon dialing the first address of the target telephone, the first address of the source telephone is retrieved without requiring manual intervention and then used to retrieve the second address of the target telephone without requiring manual intervention. The call is then seamlessly directed over the IP network between the source telephone and the target telephone using their respective second addresses. The second address of the source telephone is retrieved by the target telephone in symmetrical manner.

### FIELD OF THE INVENTION

This invention relates to IP telephony.

### BACKGROUND OF THE INVENTION

Notwithstanding the proliferation of IP Telephony, it still requires less effort to effect telephone communication using PSTN or cellular telephones than using IP telephones. IP networks frequently employ Network Address Translation (NAT) to allow a single device, such as a router, to act as an agent between the Internet (or “public network”) and a local (or “private”) network. The NAT may map an unregistered IP address to a registered IP address on a one-to-one basis or from a group of registered IP addresses, or it may map multiple unregistered IP addresses to a single registered IP address by using different ports. This is known also as PAT (Port Address Translation), single address NAT or port-level multiplexed NAT. By such means, only a single, unique IP address is required to represent an entire group of computers.

IP addresses allocated locally in local area networks (LANs) may overlap with registered IP addresses used on another network. To avoid conflict, the router must maintain a lookup table of these addresses so that it can intercept them and replace them with registered unique IP addresses. This must be done both for incoming and outgoing traffic, thus requiring the NAT router to translate the “internal” addresses to registered unique addresses as well as translate the “external” registered addresses to addresses that are unique to the private network.

If the IP telephone is placed behind the NAT or NAPT (Network Address and Port Translation) device, as is typical in concurrent IP networks, calling the IP telephone becomes even more difficult to manage because the calling party does not directly know its own IP address.

It would therefore be desirable to provide a dual-mode telephone that operates as a PSTN or cellular telephone when used to call another PSTN or cellular telephone and operates automatically as an IP telephone when the called party has an IP address.

U.S. Pat. No. 6,876,648 published Apr. 5, 2005 to Unidata Communication Systems et al. discloses an Internet based telephone apparatus for embodying a telephone-to-telephone type of Internet based telephone, the apparatus having a gateway function where communication is possible between a general telephone connected via PSTN with another Internet based telephone connected through Internet network without separate Internet telephone gateway installed between the Internet network and PSTN, and a dual channel communication function where a communication is possible by being connected to a third Internet based telephone when there is a communication connection between a general telephone connected via PSTN and a second Internet based telephone connected through Internet network.

U.S. 2005/053051 published Mar. 10, 2005 in the name of Siemens Communications Inc. discloses a dual mode packet phone comprising a first connector to connect the phone with a data network, and a second connector to connect the phone with a backup network. The phone automatically switches between the data and backup networks in the event that the data network fails to process the call in a timely manner.

WO 99/12365 (Hyllander et al.) published Mar. 11, 1999 discloses a communication system including a cellular radio communication network, such as a Global System for Mobile Communication (GSM) network, that is adapted to enable a GSM subscriber to make an Internet telephone call to an Internet user. In particular, a ‘short message service’ (SMS) is used to transfer address information for the Internet user to an Internet server. The system also relates to a method for enabling a GSM subscriber to make an Internet telephone call to an Internet user using SMS to transfer address information for the Internet user. But this is done by means of a dedicated telephony/Internet server that intercepts GSM calls and redirects them via the Internet. The server provides a special service that requires a calling party to access the server in order to reach another GSM subscriber using VoIP. To this end, a ‘short message service’ (SMS) is used to transfer address information for the Internet user to an Internet server, which is then able to map an incoming GSM number of a target telephone to a corresponding IP address. There is no provision for the calling party to dial the GSM number of the target telephone directly in order to establish IP communication.

U.S. Pat. No. 6,424,648 (Ng et al.) published Jul. 23, 2002 discloses a method and system for automatically establishing a phone call over an Internet connection, wherein a caller party automatically dials a telephone number of a recipient party to establish a telephone phone call connection. The caller party automatically initiates a dialing routine to notify the recipient party of an intended phone call connection across an Internet connection. The caller and recipient parties automatically end the telephone call connection in response to the recipient party detecting the dialing routine by the caller party. The caller and recipient parties each automatically undertake to make a separate connection with an Internet service provider and then make a connection to a directory service on the Internet. Each of the caller and recipient parties automatically provide their respective Internet protocol address and telephone number, and the caller party submits the recipient party's telephone number. Each of the caller and recipient party automatically complete the Internet connection for the intended phone call connection.

US 2004/017910 (Joksang et al.) published Jan. 29, 2004 discloses a dual phone that recognizes one of ISDN mode, IP mode, and external connection mode from a user input, and connects or releases a voice path between an ISDN phone and the IP phone based on the recognized mode, thereby enabling calling between an external ISDN phone and an IP phone. In the case of an origination call, the ISDN phone circuit unit and the IP phone circuit unit operate in the same manner as the existing ISDN phone and IP phone. That is, if a dial tone is heard when the handset is picked up, a calling party may dial the called party's phone number. At this time, in order to operate the ISDN phone circuit unit, the calling party should press the ISDN/IP button, while in order to operate the IP phone circuit unit, the calling party should press the ISDN/IP button once again. In other words, the ISDN/IP button is toggled. There is no suggestion to allow seamless VoIP redirection to a target telephone by dialing the PSTN address of the target telephone.

US 2004/017901 (Lim) published Jan. 29, 2004 discloses a communications terminal that operates in multiple modes including a wired phone mode, an Internet phone mode, and a combined mode. The terminal includes a wired phone unit and an IP phone unit which separately processes calls to/from PSTN- and Internet-communications networks. The terminal also includes a processor which processes a call through a voice path which connects the wired phone unit and the IP phone unit in a third mode of operation which is referred to as an external connection mode.

None of the above references allows seamless routing of a telephone call via VoIP over an Internet connection between two subscribers to a non-IP telephone network (such as PSTN or Cellular) using dual mode telephones that are compatible with VoIP and an appropriate non-IP protocol, whereby a source subscriber can call a target subscriber by dialing the target subscriber's number of the non-IP network.

### SUMMARY OF THE INVENTION

It is an object of the invention to provide a method, system and enhanced telephone having two communication ports having respective first and second addresses for connecting to a non-IP network and an IP network, respectively for allowing seamless routing of a VoIP telephone call via an IP network between a source telephone and a target telephone by dialing the first address of the target telephone.

This object is realized in accordance with a first aspect of the invention by a method of effecting seamless routing of a VoIP telephone call via an IP network between a source telephone and a target telephone both having two communication ports having respective first and second addresses for connecting to a non-IP network and an IP network, respectively, by dialing the first address of the target telephone, the method comprising:
(a) retrieving the first address of the source telephone without requiring manual intervention;
(b) using the first address of the target telephone input to the source telephone to retrieve the second address of the target telephone without requiring manual intervention; and
(c) seamlessly directing VoIP between the source telephone and the target telephone using their respective second addresses.

In one embodiment of the invention, the source and target telephones are dual mode IP/PSTN telephones that are both connected to both the PSTN and an IP network, such as the Internet. But the invention is also applicable for use with any dual mode telephone having a VoIP compatible port as well a non-IP port that is connectable to a different communications network for effecting non-IP communication with another telephone connected to the same network. So, for example, the invention is applicable also to dual mode cellular/IP that effect IP communication using Packet Data wireless services such as Wi-Fi or GPRS.

According to a second aspect of the invention there is provided a dual mode, dual protocol telephone, comprising:

a first communication port having a first address for connecting to a non-IP network,

a second communication port having a second address for connecting to an IP network,

a user interface for allowing entry or selection of the first address of a remote similar dual mode, dual protocol telephone with which VoIP communication is required between the respective second communication ports of both telephones, and

a processing unit adapted to retrieve the respective second addresses of both telephones and to seamlessly establish a VoIP communication therebetween.

In the case where the dual mode, dual protocol telephone is coupled to the Public IP network via a NAT, the address will minimally include Public IP and Port number so as to provide sufficient information necessary for NAT traversal for establishing peer-to-peer communication over IP. This ensures that a message conveyed from the source telephone includes the respective Private IP addresses of the source and target telephones as well as their respective Public IP addresses and the port numbers of the port in their corresponding domestic routers or NAT servers. In this connection, it is to be noted that port numbers of the target phone are known to its domestic NAT, via the rendezvous server, which provides them to the target phone, but not to the source phone, which must know them to initiate direct, peer-to-peer call with the target. In other words, the source phone should send its packets to the target phone's public IP plus port, in order to reach target phone. The target phone's domestic NAT will translate Public IP address plus Port number to Private IP address of the target phone, and therefore be able to resolve the address, otherwise it may not be able to do this, given that there may be more than one target phone connected to the target domestic NAT and having the same logical port number. It is to be noted that this is only one possible implementation of a NAT. Other implementations are also known and all possible implementations are embraced by the invention. A further discussion of NAT Traversal may be found in the following publications:
NAT Traversal for Multimedia over IP by Newport Networks
NAT Traversal in SIP, White Paper by Baruch Sterman et al. of Kayote Networks
Peer-to-Peer Communication Across Network Address Translators by Bryan Ford et al.

All of these publications are accessible over the Internet and are included in the File Wrapper of the present US application by way of an IDS.

The source NAT maps the source telephone Private IP address to a logical port number of the source NAT to which the source telephone is connected with the. A message sent from the source telephone to the target telephone is first received by the target NAT having the public IP address of the target telephone. The target NAT relays the incoming data to the port number in the target NAT embedded in the message so as to convey the message to the target telephone. When a reply message is relayed by the target telephone to the source telephone, a symmetrical procedure is carried out.

In contrast to a dual mode, dual protocol telephone that is coupled to the Public IP network via a NAT, in the case of a dual mode, dual protocol telephone coupled to the Public IP network directly, the address need include only the Public IP of the respective telephone.

Therefore in the context of the invention and the appended claims, it is to be understood that the term “address” envisages any information that enables data to be conveyed unambiguously to an identified target telephone from an identified source telephone. As noted, the address minimally includes the Public IP address of a telephone when connected directly to the Public IP network; and may further include the port number of a NAT via which the telephone is coupled to the IP network address. Alternatively or additionally, the address may also include the Private IP address: all depending on the NAT's ability to map a Private IP address to the corresponding port to which the telephone is connected, and vice versa.

A PSTN/VoIP telephone according to the invention may further include a Customer Premises Equipment Call Waiting Caller ID protocol emulator coupled to the processing unit for conveying a retrieved IP address and NAT traversal information of the dual mode PSTN/VoIP telephone to a remote PSTN/VoIP telephone. Likewise, a Cellular/IP (e.g. over WiFi or GPRS) telephone according to the invention may fuirther support an SMS protocol conveying a retrieved IP address and NAT traversal information of the dual mode Cellular/VoIP telephone to a remote Cellular/VoIP telephone.

### BRIEF DESCRIPTION OF THE DRAWINGS

In order to understand the invention and to see how it may be carried out in practice, an embodiment will now be described, by way of non-limiting example only, with regard to seamlessly routing a VoIP telephone call via an 1P network between a pair of dual mode PSTN/IP telephones and with reference to the accompanying drawings, in which:

FIGS. 1 and 2 are pictorial representations of a system according to exemplary embodiments for allowing a dual mode PSTN/VoIP source telephone to establish VoIP communication seamlessly with a dual mode PSTN/VoIP target telephone;

FIGS. 3a and 3b are block diagrams showing respective functionalities of dual mode PSTN/VoIP and cellular/VoIP telephones for use in the system shown in FIG. 2;

FIG. 4 is a schematic ‘Call Flow’ diagram showing signaling between two PSTN telephones conveying an instant message using conventional Call Waiting Caller ID protocol according to an exemplary embodiment;

FIG. 5 is a flow diagram showing the principal operations carried out by the dual mode PSTN/VoIP source telephone in FIGS. 1 and 2;

FIG. 6 is a flow diagram showing the principal operations carried out by the dual mode dual protocol target telephone in FIGS. 1 and 2;

FIG. 7 is a flow diagram showing the principal operations carried out by dual mode PSTN/VoIP telephones for conveying their IP addresses to each other; and

FIG. 8 is a flow diagram showing the principal operations carried out by a dual mode PSTN/VoIP telephone in order to determine its IP address.

### DETAILED DESCRIPTION OF EXEMPLARY EMBODIMENTS

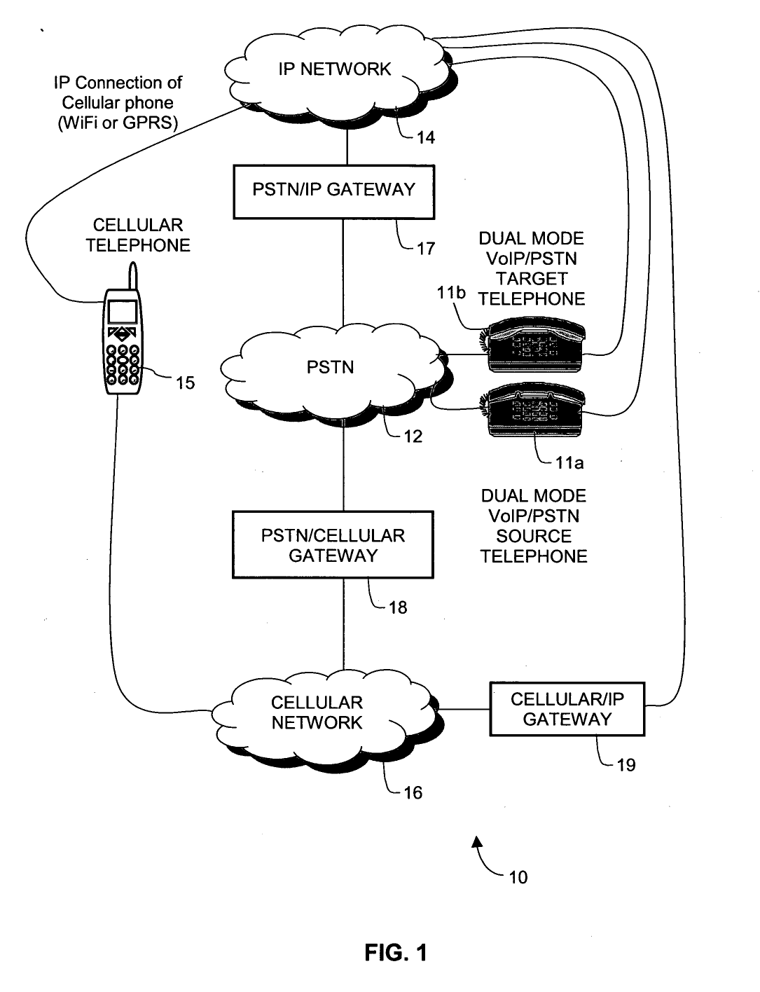

FIG. 1 is a pictorial representation of a telephone system 10 for conveying VoIP messages between a dual mode source telephone 11a and a dual mode target telephone 11b both connected to the PSTN 12. The dual mode source telephone 11a is also adapted to effect VoIP communication with a VoIP target telephone 11b coupled to an IP network 14, and with a cellular target telephone 15 connected to a cellular network 16 as well as to an IP network 14. In all cases, VoIP communication is established by the dual mode source telephone 1 la dialing the PSTN number of the required target telephone.

For the sake of completeness, the system 10 includes a PSTN/IP gateway 17 a PSTN/Cellular gateway 18 and a Cellular/IP Gateway 19 for conveying signaling and media from one network to the other with regard to single mode telephones or other telephones that are not enhanced dual mode telephones according to the invention. For such telephones, the respective gateways operate in a manner well known in the art to convert the signals between PSTN and IP or PSTN and Cellular or Cellular and IP protocols and vice versa. The PSTN/IP gateway 17, the PSTN/Cellular gateway 18 and the Cellular/IP Gateway 19 are all adapted to emulate the Call Waiting Caller ID protocol in respect of the source telephones in the respective networks.

However, the need for protocol conversion that is the raison d'êitre of these gateways is eliminated for enhanced dual mode telephones according to the invention, which communicate either over PSTN or cellular only (during an initial session wherein they exchange their IP addresses) or (subsequently) via IP only. Therefore, no further discussion of the gateways or their operation, which in any case are known per se, will be given, since they are not required for communication between enhanced dual mode telephones according to the invention.

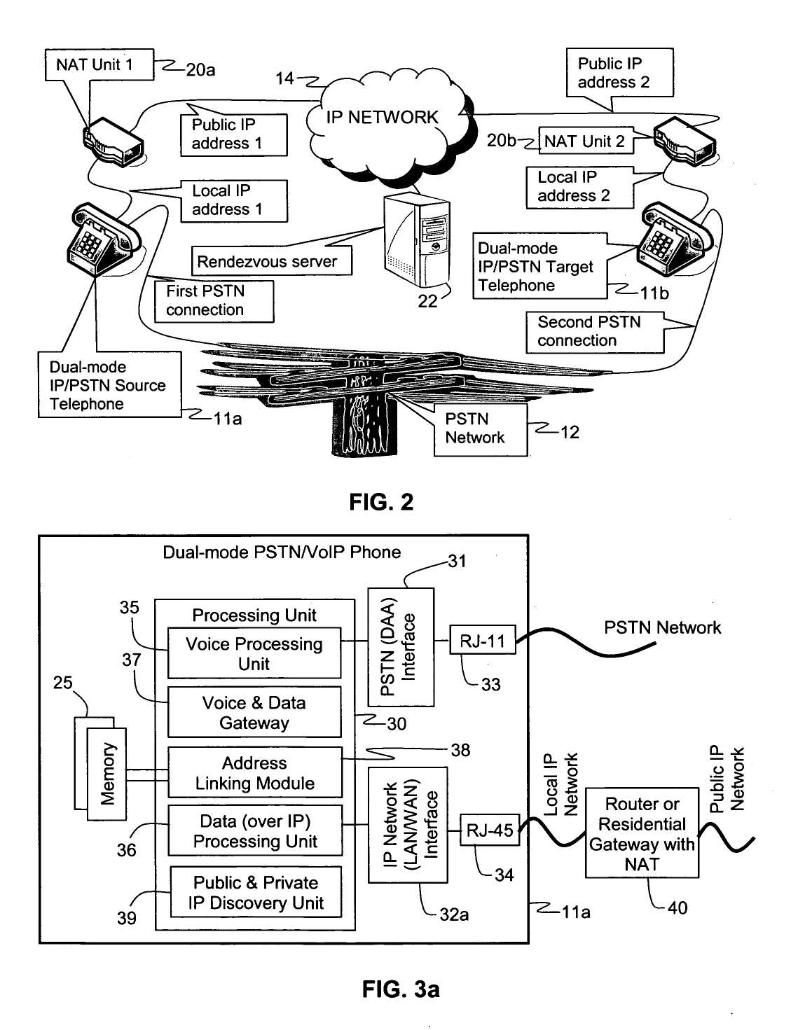

FIG. 2 shows a detail of the system 10 described above with reference to FIG. 1 wherein the source and target telephones 11a and 11b are connected to respective LANs which are connected to the Internet via respective Network Address Translation units (NAT) indicated by 20a and 20b. In such a configuration, each of the source and target telephones has two IP addresses: a first is unique to the LAN and will be referred to as a private IP address; and the second is unique to the Internet and will be referred to as a public IP address. The public IP address is effectively the IP address of the LAN to the outside world, while the private IP address is the address of a specific network node within the LAN. Thus, together the public IP address and the private IP address enable any network node in the IP network to access a specific node in the LAN.

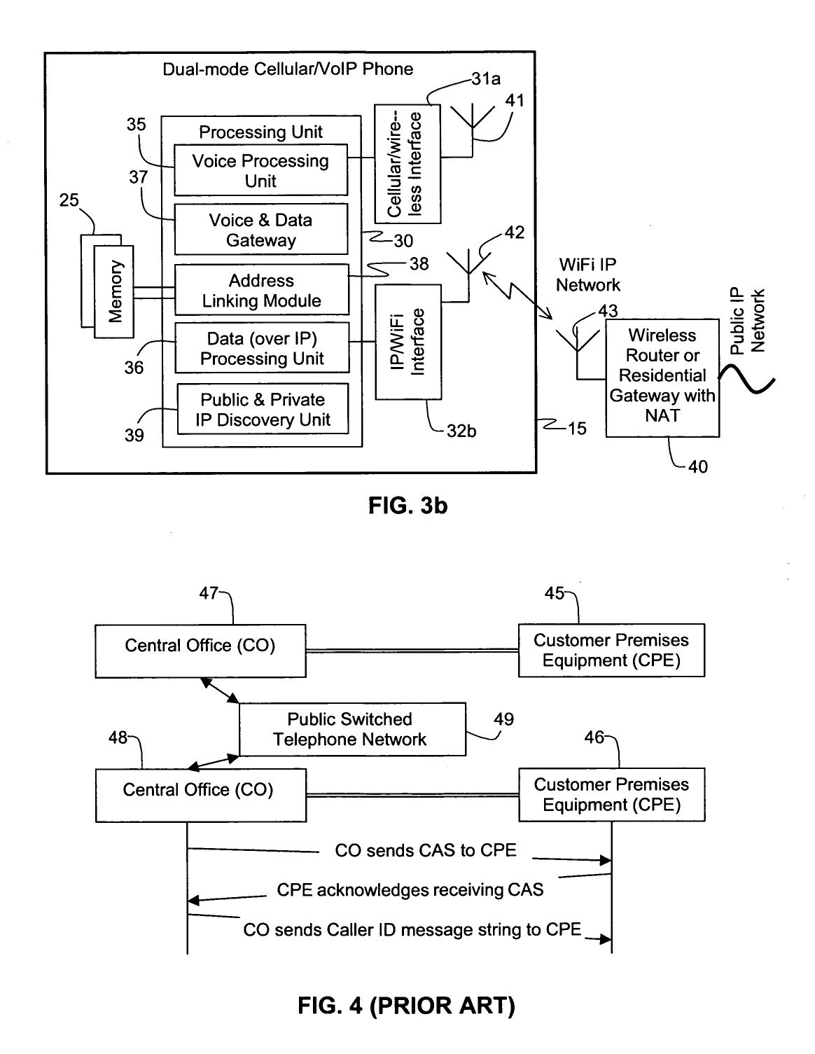

FIG. 3a is a block diagram showing the functionality of a dual mode, dual protocol PSTN/VoIP telephone 11a for use in the system shown in FIG. 2. The dual mode PSTN/VoIP telephone 11a includes a memory 25 coupled to a processing unit 30 coupled to a PSTN interface 31 a and a LAN/WAN interface 32a. The memory 25 stores a phone book of contacts and corresponding PSTN and IP addresses. The phone book constitutes a lookup table for mapping non-IP addresses (such as PSTN and Cellular telephone numbers) to IP addresses. But it also allows the telephone to establish IP communication with all subscribers who have in the past used a similar dual mode PSTN/VoIP telephone to establish IP connection to the source telephone; or with whom the source telephone has previously established IP connection. This may be done under program control in a manner that is transparent to a user of the source telephone so as to update its own IP address in the corresponding phone book of all its contacts. The reason why this may be necessary is to cater for situations where its IP address changes for any reason and to ensure that any such changes are notified immediately to its phone book contacts, since otherwise they will not be able to initiate IP connection to the source telephone.

The PSTN interface 31a is connected to an RJ-11 telephone socket 33 (constituting a first communication port) for coupling to the PSTN. Likewise, the LAN/WAN interface 32a is connected to an RJ-45 socket 34 (constituting a second communication port) for coupling to the Internet. The processing unit 30 includes a voice processing unit 35 for processing the voice to/from the PSTN, and a data processing unit 36 for processing the data to/from the IP network. The processing unit 30 also includes a voice and data gateway 37 that converts the voice to IP packets, and an address linking module 38 that is coupled to the memory 25 and is responsive to a first address for extracting the corresponding second address from the memory. The address linking module 38 includes or is coupled to a user interface (such as an alpha-numeric keypad and scrolling keys as shown in FIG. 1) for allowing entry or selection of the first address of a remote dual mode, dual protocol telephone with which VoIP communication is required between the respective second communication ports of both telephones. A public and private IP discovery unit 39 serves to connect to the rendezvous server 22 (shown in FIG. 2) in order to extract the public IP address of the telephone and to execute the UPnP function in a NAT 40, if the latter exists. UPnP is an acronym for Universal Plug and Play and is a technology that allows applications to discover and configure network components, including NATs and Firewalls, which are enabled with UPnP software. UPnP is merely one way to allow unsolicited incoming calls to a network node to infiltrate the firewall. However, it is to be understood that the invention describes UPNP by way of example only since it is probably the predominant approach currently in use. Many other solutions are known to achieve NAT Traversal so as to route an incoming call directed to the public IP address of a NAT to a specific port thereof corresponding to a desired private IP address. Some of them, such as the so-called STUN protocol may be also applicable; and others such as Application Layer gateway (ALG) may not be suitable for domestic or small office installations owing to their need for advanced configuration and managerial skills required for their installation and maintenance. The present invention is not primarily concerned with network security and therefore any other approach to providing NAT Traversal may be used by a dual mode, dual protocol telephone according to the invention.

Although the above description is directed specifically to PSTN/VoIP telephones, it is to be understood that the principles apply to other dual mode, dual protocol telephones such as Cellular/IP. Thus, FIG. 3b is an equivalent block diagram showing the functionality of the dual mode, dual protocol Cellular/VoIP telephone 15 shown in FIG. 2. It will be seen that most of the functionality is identical to that of the dual mode, dual protocol PSTN/VoIP 11a described above with reference to FIG. 3a and so will not be repeated here. The principal differences are that the PSTN interface 31a is replaced by a Cellular wireless interface 31b coupled to an antenna 41, which effects cellular communication with the Cellular network 16 (shown in FIG. 1). Likewise, the LAN/WAN interface 32a is replaced by a WiFi interface 32b coupled to an antenna 42, which effects WiFi communication with the public IP network via an antenna 43 coupled to the NAT 40.

FIG. 4 is a schematic ‘Call Flow’ diagram showing signaling between two PSTN telephones conveying an instant message using conventional Call Waiting Caller ID protocol. The Call Waiting Caller ID transmission protocol requires two parties, a Central Office (CO) and Customer Premises Equipment (CPE), also known as a Telephone Terminal or simply Telephone. CPEs 45 and 46 are interconnected via respective COs 47 and 48 switched via the PSTN 49, thereby allowing regular voice communication between first and second parties operating the CPEs 45 and 46, respectively. If a third party calls the second party CPE 46 during this call, the respective CO 48 disconnects the voice path from CPE 45 to CPE 46 and sends a so-called CPE Alert Signal (CAS) to the CPE 46. CPE 46, upon receiving the CAS, acknowledges receipt to CO 48 and prepares to receive the Caller ID message string. CO 48, upon receiving the acknowledge signal from CPE 46, sends Caller ID message string, to CPE 46. Upon receiving this message, CPE 46 displays it allowing the second party to accept or reject the third party's call. In order for such a scheme to operate, the CPE 46 (constituting a “target telephone”) must be equipped to recognize Customer Premises Equipment Call Waiting Caller ID protocol. This is fast becoming an accepted feature of most regular PSTN telephones now being sold. Call Waiting Caller ID protocol has been widely deployed during last years and tens of millions of PSTN telephone terminals supporting it have been sold and are working in consumer premises.

In similar manner, dual mode, dual protocol Cellular/IP telephones may exchange their IP address using SMS, for example according to the mechanism described in above-mentioned WO 99/12365.

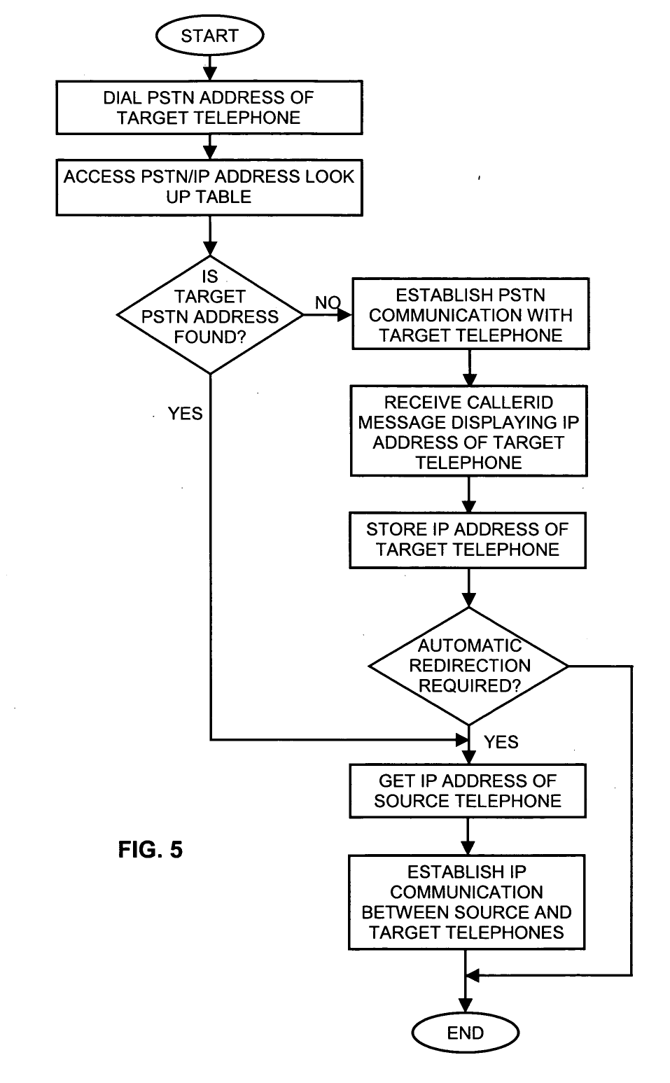

FIG. 5 is a flow diagram showing the principal operations carried out by the dual mode PSTN/VoIP source telephone 11a shown in FIGS. 1 and 2 in accordance with an exemplary embodiment. The PSTN/VoIP source telephone 11a initially dials the PSTN address of the target telephone 11b. If VoIP communication between the two telephones has previously been established, the IP address of the target telephone 11b will already have been communicated to the source telephone 11a and stored in a lookup table in its memory. So, when a user dials the PSTN address of the target telephone 11b, the processing unit of the source telephone 11a accesses the memory to determine if the corresponding IP address of the target telephone 11b is stored in its lookup table. If so, the IP address of the source telephone 11a is obtained as described below with reference to FIG. 8, and VoIP communication is established between the two IP addresses. This is done seamlessly without having established PSTN connection between the two telephones.

When a PSTN call is initiated for the first time between the source and target telephones, there are two options. According to one option, the PSTN call continues in normal manner until terminated by the source subscriber who may, of course, immediately redial the PSTN address of the target telephone in order to establish VoIP communication since the corresponding IP address of the target telephone is now known to the source telephone. According to an alternative scenario, the PSTN call is automatically terminated and VoIP communication established seamlessly.

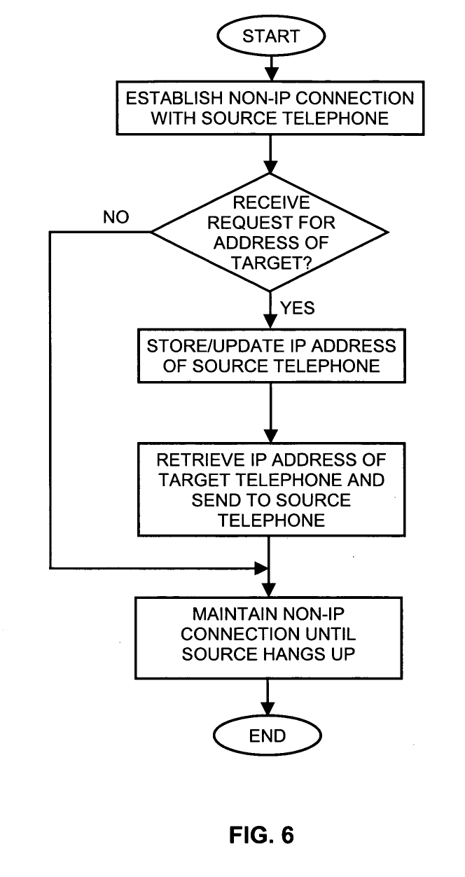

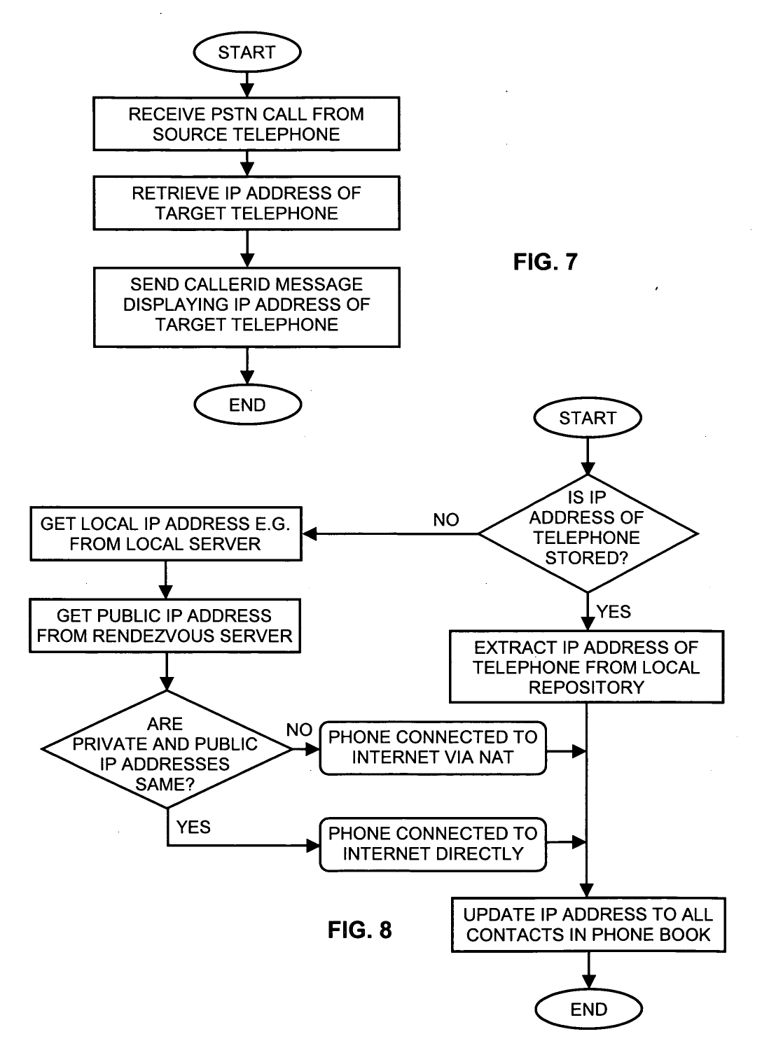

FIG. 6 is a flow diagram showing the complementary operations carried out by the dual mode PSTN/VoIP target telephone 11b in accordance with an exemplary embodiment. On receiving a PSTN call from the source telephone 11a, it establishes a PSTN call with the source telephone in known manner. If the source telephone is a normal single mode or non-enhanced telephone, the target telephone will not be requested to convey its IP address to the source telephone. In this case, the PSTN call is maintained until the source telephone hangs up. However, a dual mode PSTN/VoIP source telephone according to the invention, requests the target telephone to send its IP address. It attempts to do this regardless of the type of target telephone, since unless the source telephone is able to map in its memory 25 an IP address to the targeted PSTN address, it has no way of knowing (at this stage) whether or not the target telephone is a dual mode PSTN/VoIP device. Of course, a regular or non-enhanced PSTN telephone is unable to process the request, but this scenario is not within the scope of FIG. 6 which relates to the actions taken by an enhanced target telephone. On receiving the request to send its IP address to the source telephone, the target telephone retrieves its IP address (as explained below with reference to FIG. 8) and conveys it to the source telephone, for example using Call Waiting Caller ID protocol as described below with reference to FIG. 7. The target telephone also stores or updates the IP address of the source telephone, which may likewise be conveyed using Call Waiting Caller ID protocol, in its lookup table, so that when it subsequently wishes to initiate a call to the source telephone, seamless redirection will be effected when the target telephone dials the PSTN number of the source telephone.

It is to be noted that the flow diagrams are intended to show the principal operations carried out by the source and target telephones and so not necessarily dictate an order in which they are carried out. So, for example, in FIG. 6 it is not important whether the target telephone conveys its IP address to the source telephone and only then stores the IP address of the source telephone; or whether the target telephone first stores the IP address of the source telephone and only then conveys its IP address to the source telephone.

FIG. 7 shows the principal operations carried out by the dual mode PSTN/VoIP target telephone 11b in accordance with an exemplary embodiment for conveying its IP address to the source telephone. On receiving a request, as described above with reference to FIG. 6, it retrieves its IP address as described below with reference to FIG. 8 and conveys the IP address to the source telephone 11a, which then stores it in its memory. The IP address of the target telephone 11b may be conveyed over the PSTN to the source telephone 11a using Call Waiting Caller ID protocol. But the invention is not limited to the use of CallerID for conveying the IP addresses. Thus, at its most simple, the IP address could be conveyed vocally and entered manually by the source subscriber so as to be available for subsequent use. It will be understood that such a cumbersome operation is only effected once for each target subscriber: thereafter seamless VoIP communication is automatically effected by dialing the PSTN address of the target telephone.

FIG. 8 is a flow diagram showing the principal operations carried out by a dual mode PSTN/VoIP telephone in order to determine its IP address in accordance with an exemplary embodiment. Each telephone may be connected to the Internet either directly or via a LAN. In the former case, the telephone will have only a public IP address. In the case where it is connected via a LAN, it will have a public IP address that accesses the LAN and a private IP addresses that informs the LAN server to which node in the LAN communication is to be directed. The public IP address is retrieved from a suitable public server, such as a rendezvous server, in known manner. The private IP address, if assigned, is retrieved from a suitable local repository, such as DHPC server, in known manner. For a telephone connected to the Internet either directly, the Private IP address observed by the telephone is actually its Public IP address. Knowledge of whether the telephone is connected directly or indirectly to the Internet may be used to establish what address data to send to a remote telephone, when exchanging IP addresses. Once the private and public IP addresses have been obtained, they may be stored in memory for subsequent direct access by the telephone without the need to access the servers. However, IP addresses (both private and public) are apt to change since they are normally accessed via aliases which are mapped to the respective IP addresses in a memory of the server. So it is preferable for the telephone to retrieve the IP addresses from the respective servers periodically even if they are stored in memory and to update the memory accordingly. By the same token the IP address of the target telephone is also apt to change unpredictably. In order to cope with sporadic address changes and ensure that the stored target addresses are always current whenever a telephone updates its ‘own’ IP address as explained above, it seamlessly informs all its phone book contacts stored in the memory 25 over IP.

It will be appreciated that modifications will be apparent to those of average skill in the art without departing from the spirit of the invention. In particular, while the preferred embodiment has been described with particular regard to a dual mode PSTN/IP telephone it is equally applicable to cellular/IP telephones. Likewise, while it has been described to relay IP addresses during a PSTN connection using Call Waiting Caller ID protocol and during a Cellular connection using SMS, any other suitable means may be employed. Thus, as noted, the IP addresses can be exchanged manually in an initialization process and then stored. Subsequent updating of IP addresses will continue to be effected automatically via the IP network thus ensuring that the initialization process, even if performed manually, need ever be performed only once. It should also be noted that since there is only a need to obtain for a source telephone the target telephone's IP address over the PSTN, or other non-IP network, only once during first use, all subsequent uses will rely on the fact that the target telephone's IP address is already stored and mapped to its PSTN number. The invention as claimed is intended to cover such subsequent communication, as well as a telephone that has dual ports for effecting IP and non-IP communication and is able to map a non-IP address to a corresponding IP address of a target telephone in order to establish seamless IP communication by dialing the non-IP address thereof.

1. A method of effecting seamless routing of a VoIP telephone call via an IP network between a source telephone and a target telephone both having two communication ports having respective first and second addresses for connecting to a non-IP network and an IP network, respectively, by dialing the first address of the target telephone, the method comprising:
(a) retrieving the first address of the source telephone without requiring manual intervention;
(b) using the first address of the target telephone input to the source telephone to retrieve the second address of the target telephone without requiring manual intervention; and
(c) seamlessly directing VoIP between the source telephone and the target telephone using their respective second addresses.

2. The method according to claim 1, wherein the second address of the source telephone is a unique public IP address, and retrieving the second address of the source telephone includes periodically accessing a public server for retrieving the unique public IP address of the source telephone.

3. The method according to claim 2, further including storing the unique public IP address of the source telephone in a memory of the source telephone so as to allow subsequent retrieval without accessing the public server.

4. The method according to claim 1, wherein the second address of the source telephone comprises a unique public IP address and a private IP address that is unique to a local area network that contains the source telephone but is publicly non-unique, and retrieving the second address of the source telephone includes:
i) periodically accessing a public server for retrieving the unique public IP address of the source telephone; and
ii) accessing a local repository to extract the private IP address of the source telephone.

5. The method according to claim 4, further including storing the unique public IP address of the source telephone in a memory of the source telephone so as to allow subsequent retrieval without accessing the public server.

6. The method according to claim 4, further including storing the private IP address of the source telephone in a memory of the source telephone so as to allow subsequent retrieval without accessing an external device.

7. The method according to claim 6, wherein accessing a local repository includes accessing a memory of the source telephone.

8. The method according to claim 4, wherein accessing a local repository includes accessing a DHPC server.

9. The method according to claim 4, further including:
i) accessing a list of phone book contacts to obtain respective second addresses of all phone book contacts having a telephone with two communication ports having respective first and second addresses for connecting to a non-IP network and an IP network; and
ii) notifying changes in the second address of the source telephone to said phone book contacts via IP communications between the second address of the source telephone and the respective second addresses of the phone book contacts.

10. The method according to claim 1, wherein using the first address of the target telephone to retrieve the second address of the target telephone includes:
i) effecting a non-IP call to the first address of the target telephone for receiving therefrom a message containing the second address of the target telephone; and
ii) storing the second address of the target telephone in a local repository that maps the second address of the target telephone to the first address of the target telephone so as to allow subsequent retrieval of the second address of the target telephone in response to its first address.

11. The method according to claim 10, including effecting a non-IP call via a PSTN and conveying said message using Central Office Call Waiting CallerID protocol.

12. The method according to claim 10, including effecting a non-IP call via a Cellular network and conveying said message using SMS.

13. The method according to claim 10, further including conveying in said message NAT traversal information.

14. The method according to claim 10, wherein storing the second address of the target telephone in the local repository includes storing the address in a memory of the source telephone.

15. The method according to claim 1, wherein using the first address of the target telephone input to the source telephone to retrieve the second address of the target telephone includes retrieving the second address of the target telephone from a local repository that maps the second address of the target telephone to the first address of the target telephone.

16. The method according to claim 15, wherein retrieving the second address of the target telephone from a local repository includes retrieving the second address of the target telephone from a memory of the source telephone.

17. A dual mode, dual protocol telephone, comprising:
a first communication port having a first address for connecting to a non-IP network,
a second communication port having a second address for connecting to an IP network,
a user interface for allowing entry or selection of the first address of a remote similar dual mode, dual protocol telephone with which VoIP communication is required between the respective second communication ports of both telephones, and
a processing unit adapted to retrieve the respective second addresses of both telephones and to seamlessly establish a VoIP communication therebetween.

18. The dual mode, dual protocol telephone according to claim 17, wherein:
a memory is coupled to the processing unit for storing first addresses of dual mode, dual protocol telephones to corresponding second addresses thereof, and the processing unit includes an address linking module coupled to the memory and being responsive to a first address for extracting the corresponding second address from the memory.

19. The dual mode, dual protocol telephone according to claim 18, wherein the processing unit includes:
a public and private IP discovery unit for obtaining a public IP address of the source telephone and a private IP address thereof if the source telephone is part of a LAN.

20. A dual mode, dual protocol source telephone according to claim 19, wherein the processing unit is adapted to:
access a public server periodically for retrieving or renewing the public IP address of the dual mode, dual protocol source telephone,
access a local repository to extract the private IP address of the dual mode, dual protocol source telephone,
access the memory to obtain respective second addresses of all phone book contacts having dual mode, dual protocol telephones, and
notify changes in the second address of the dual mode, dual protocol source telephone to said phone book contacts via IP communications between the second address of the source telephone and the respective second addresses of the phone book contacts.

21. The dual mode, dual protocol telephone according to claim 17, wherein the second addresses of the source and target telephones each include a private IP address, a public IP address and a port number of the router or NAT to which the telephone is connected.

22. A dual mode, PSTN/VoIP telephone according to claim 17, further including a Central Office Call Waiting Caller ID protocol emulator coupled to the processing unit for conveying the retrieved second address of the dual mode PSTN/VoIP telephone to a remote dual mode, PSTN/VoIP telephone.

23. A dual mode, Cellular/VoIP telephone according to claim 17, further including a SMS protocol emulator coupled to the processing unit for conveying the retrieved second address of the dual mode Cellular/VoIP telephone to a remote dual mode, Cellular/VoIP telephone.
